(19) United States
(12) Patent Application Publication
(10) Pub. No.: US 2025/0372696 A1
(43) Pub. Date: Dec. 4, 2025

(54) SOLID ELECTROLYTE, LITHIUM SECONDARY BATTERY INCLUDING THE SAME, AND PREPARATION METHOD THEREOF

(71) Applicant: ELECTRONICS AND TELECOMMUNICATIONS RESEARCH INSTITUTE, Daejeon (KR)

(72) Inventors: YOUNG SAM PARK, Daejeon (KR); Seokyoon YOON, Daejeon (KR); Dong Ok SHIN, Daejeon (KR); Young-Gi LEE, Daejeon (KR)

(21) Appl. No.: 19/061,151

(22) Filed: Feb. 24, 2025

(30) Foreign Application Priority Data
May 31, 2024 (KR) 10-2024-0071901
Aug. 21, 2024 (KR) 10-2024-0112323

(51) Int. Cl. H01M 10/056; H01M 10/052

(52) U.S. Cl. CPC H01M 10/056; H01M 10/052; H01M 2300/008; H01M 2300/0082; H01M 2300/0091

(57) ABSTRACT

Provided is a lithium secondary battery, wherein the lithium secondary battery includes a first electrode, a second electrode spaced apart from the first electrode, and a solid electrolyte disposed between the first electrode and the second electrode. The solid electrolyte includes a fiber including polytetrafluoroethylene having a number average molecular weight of 500 kg/mol to 20,000 kg/mol, and a plurality of sulfide particles. The fiber is in contact with at least some of the sulfide particles.

### CROSS-REFERENCE TO RELATED APPLICATIONS

This U.S. non-provisional patent application claims priority under 35 U.S.C. § 119 of Korean Patent Application Nos. 10-2024-0071901, filed on May 31, 2024, and 10-2024-0112323, filed on Aug. 21, 2024, the entire contents of which are hereby incorporated by reference.

### BACKGROUND

### 1. Field of the Invention

The present disclosure herein relates a lithium secondary battery, and more specifically, to a solid electrolyte and a lithium secondary battery including the same.

### 2. Description of Related Art

A secondary battery may include a lithium battery. Recently, the applicability of a lithium battery has expanded. For example, a lithium battery is widely used as a power source of an electric vehicle (EV) and an energy storage system (ESS). If a flame retardant content is increased, there may be problems in cost and performance.

An electrolyte in a lithium battery may include a liquid electrolyte or a solid electrolyte. Due to flammability and combustibility problems, a liquid electrolyte may compromise the stability of a lithium secondary battery. Various studies have been conducted to solve the above-described problems.

### SUMMARY

The present disclosure provides a solid electrolyte and a secondary battery having improved thermal stability and improved electrochemical properties.

An embodiment of the inventive concept, a lithium secondary battery includes a first electrode, a second electrode spaced apart from the first electrode, and a solid electrolyte disposed between the first electrode and the second electrode. In an embodiment, the solid electrolyte may include a fiber including polytetrafluoroethylene having a number average molecular weight of 500 kg/mol to 20,000 kg/mol, and a plurality of sulfide particles. In an embodiment, the fiber may be in contact with at least some of the sulfide particles.

In an embodiment, the fiber may have a thickness of 5 μm or less.

In an embodiment, the solid electrolyte may have a thickness of 10 μm to 99 μm.

In an embodiment, the sulfide may include LPSCl sulfide.

In an embodiment, the weight of the polytetrafluoroethylene may be 0.1 wt % to 2 wt % of the weight of the solid electrolyte.

In an embodiment, the fiber may have a shape of any one or more of a linear shape, a curved shape, and a curved shape having a branching portion.

In an embodiment, at least one of the first electrode and the second electrode may include the same particles as sulfide particles included in the solid electrolyte.

In an embodiment, the number average molecular weight of the polytetrafluoroethylene may be 10,000 kg/mol to 15,000 kg/mol.

In an embodiment, the weight of the sulfide particles may be 98 wt % to 99.9 wt % of the weight of the solid electrolyte.

In an embodiment, the number average molecular weight of the polytetrafluoroethylene may be 12,895 kg/mol.

In an embodiment of the inventive concept, a method for manufacturing a lithium secondary battery includes preparing a first electrode, preparing a second electrode, preparing a solid electrolyte, and disposing the solid electrolyte between the first electrode and the second electrode. In an embodiment, the preparing of the solid electrolyte may include preparing a plurality of sulfide particles, preparing polytetrafluoroethylene having a number average molecular weight of 500 kg/mol to 20,000 kg/mol, producing a mixture by mixing the polytetrafluoroethylene and the plurality of sulfide particles, producing a dough by heat-pulverizing the mixture, and producing a solid electrolyte by heat-pressing the dough.

In an embodiment, in the producing of the mixture, the weight ratio between the polytetrafluoroethylene and the sulfide particles may be 0.1:99.9 to 2:98.

In an embodiment, in the preparing of the polytetrafluoroethylene, the number average molecular weight of the polytetrafluoroethylene may be 10,000 kg/mol to 15,000 kg/mol.

In an embodiment, in the preparing of the plurality of sulfide particles, the plurality of sulfide particles may include LPSCl sulfide.

In an embodiment, the producing of the dough may be performed at 60° C. to 140° C.

In an embodiment, in the producing of the dough, the heat-pulverization may be performed for 100 seconds to 400 seconds.

In an embodiment, in the producing of the solid electrolyte, the heat-pressing may be unidirectional heat-pressing.

In an embodiment, in the producing of the solid electrolyte, the heat-pressing may be performed at 60° C. to 140° C.

In an embodiment, in the producing of the solid electrolyte, the heat-pressing may be performed by using a plurality of press rolls.

In an embodiment of the inventive concept, a method for producing a solid electrolyte for a lithium secondary battery includes preparing a plurality of sulfide particles, preparing polytetrafluoroethylene having a number average molecular weight of 500 kg/mol to 20,000 kg/mol, producing a mixture by mixing the polytetrafluoroethylene and the plurality of sulfide particles, producing a dough by heat-pulverizing the mixture, and producing a solid electrolyte by heat-pressing the dough.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a cross-sectional view illustrating a lithium secondary battery according to an embodiment of the inventive concept;

FIG. 1B is a cross-sectional view illustrating a lithium secondary battery according to an embodiment of the inventive concept;

FIG. 2 is an enlarged view of region A of FIG. 1A and FIG. 1B;

FIG. 3A is a flowchart of a method for producing a solid electrolyte according to an embodiment of the inventive concept;

FIG. 3B is a flowchart of a method for manufacturing a secondary battery according to an embodiment of the inventive concept;

FIG. 4A shows polytetrafluoroethylene (PTFE) particles of Example 1-1;

FIG. 4B shows the result of SEM observation of Example 1-1;

FIG. 4C shows polytetrafluoroethylene (PTFE) particles of Example 1-2;

FIG. 4D shows the result of SEM observation of Example 1-2;

FIG. 4E shows polytetrafluoroethylene (PTFE) particles of Example 1-3;

FIG. 4F shows the result of SEM observation of Example 1-3;

FIG. 4G shows polytetrafluoroethylene (PTFE) particles of Example 1-4;

FIG. 4H shows the result of SEM observation of Example 1-4;

FIG. 4I shows polytetrafluoroethylene (PTFE) particles of Example 1-5;

FIG. 4J shows the result of SEM observation of Example 1-5;

FIG. 5A shows the result of SEM observation of Example 2-2;

FIG. 5B shows the result of SEM observation of Example 2-3;

FIG. 5C shows the result of SEM observation of Example 2-4;

FIG. 5D shows the result of SEM observation of Example 2-5;

FIG. 6A shows the result of a test on the degree of fibrillation according to the stress time (sec) under a condition of 100° C. for Example 1-1 to Example 1-5;

FIG. 6B shows the result of a test on the degree of fibrillation according to the stress temperature (C) under a condition of performing pulverization for 240 seconds for Example 1-1 to Example 1-5;

FIG. 7A shows the result of SEM observation of Example 3-2;

FIG. 7B shows the result of SEM observation of Example 3-4;

FIG. 7C shows the result of SEM observation of Example 3-5;

FIG. 8A shows the result of visual observation of Example 4-2 dough;

FIG. 8B shows the result of visual observation of Example 4-4 dough;

FIG. 8C shows the result of visual observation of Example 4-5 dough;

FIG. 9A and FIG. 9B show the state of Example 4-4 dough after the maximum tensile stress is applied;

FIG. 9C shows the state of Example 4-4 dough observed by SEM when the maximum tensile stress is applied;

FIG. 10A and FIG. 10B show the state of Example 4-5 dough after the maximum tensile stress is applied;

FIG. 10C shows the state of Example 4-5 dough observed by SEM when the maximum tensile stress is applied;

FIG. 10D is an enlarged view of region B of FIG. 10C;

FIG. 11 shows the result of comparing stress-strain curves of Example 4-4 dough and Example 4-5 dough;

FIG. 12 illustrates Example 5;

FIG. 13A illustrates the result of measuring the thickness of Example 5 by using a micrometer;

FIG. 13B illustrates the result of measuring the thickness of Example 5 by using a high-magnification SEM;

FIG. 14A is the result of EDS mapping of an S element of Example 5;

FIG. 14B is the result of EDS mapping of a Cl element of Example 5;

FIG. 14C is the result of EDS mapping of a P element of Example 5;

FIG. 15A shows the Coulombic efficiency according to the charge/discharge cycle number of Example 6; and

FIG. 15B shows the discharge capacity retention rate according to the charge/discharge cycle number of Example 6.

### DETAILED DESCRIPTION

In order to facilitate sufficient understanding of the configuration and effects of the inventive concept, preferred embodiments of the inventive concept will be described with reference to the accompanying drawings. However, the inventive concept is not limited to the embodiments set forth below, and may be embodied in various forms and modified in many alternate forms. Rather, these embodiments are provided so that this disclosure will be thorough and complete, and will fully convey the scope of the inventive concept to those skilled in the art to which the present invention pertains. In the accompanying drawings, elements are illustrated enlarged from the actual size thereof for convenience of description, and the ratio of each element may be exaggerated or reduced.

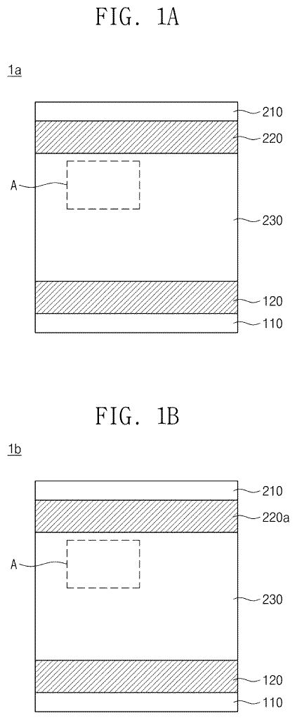

FIG. 1A is a cross-sectional view illustrating a lithium secondary battery according to an embodiment of the inventive concept.

Referring to FIG. 1A, a lithium secondary battery la according to an embodiment of the inventive concept may include a first current collector 110, a first electrode 120 on the first current collector 110, an electrolyte 230 on the first electrode 120, a second electrode 220 on the electrolyte 230, and a second current collector 210 on the second electrode 220.

The first current collector 110 may be provided. The first current collector 110 may include a metal. The first current collector 110 may include, for example, copper or aluminum. The first current collector 110 may have a thickness of, for example, 10 μm or less.

The first electrode 120 may be provided on the first current collector 110. The first electrode 120 may function as an anode. The first electrode 120 may include an anode active material, a conductive material, and a binder.

The electrolyte 230 may be disposed on the first electrode 120. The electrolyte 230 may be a medium for transferring lithium ions between the first electrode 120 and the second electrode 220. The electrolyte 230 may be a solid electrolyte. The electrolyte 230 may be a sulfide-based solid electrolyte. The electrolyte 230 may be prepared by a dry process. The electrolyte 230 may include sulfide and polytetrafluoroethylene (PTFE). The electrolyte 230 may have a thickness of 10 μm to 99 μm.

The electrolyte 230 may be prepared by a dry process. Since the dry process uses sulfide solid powder, a binder, and the like without a liquid organic solvent, and thus, does not require a process of removing the liquid organic solvent, so that the process may be simple. The dry process may easily produce a thin film.

The second electrode 220 may be disposed on the electrolyte 230. The second electrode 220 may be spaced apart from the first electrode 120 with the electrolyte 230 interposed therebetween. The electrolyte 230 may be disposed between the first electrode 120 and the second electrode 220. The second electrode 220 may function as a cathode. The second electrode 220 may include a cathode active material, a conductive material, and a binder.

The second current collector 210 may be provided on the second electrode 220. The second current collector 210 may include a metal. The second current collector 210 may include, for example, copper or aluminum. The second current collector 210 may have a thickness of, for example, 10 μm or less.

FIG. 1B is a cross-sectional view illustrating a lithium secondary battery according to an embodiment of the inventive concept.

Referring to FIG. 1B, a lithium secondary battery 1b according to an embodiment of the inventive concept is the same as that of FIG. 1A except for a second electrode 220a. Hereinafter, differences from FIG. 1A will be mainly described.

Referring to FIG. 1B, the second electrode 220a may be a composite electrode. The second electrode 220a may be, for example, a composite electrode in which sulfide particles and fiber powder are added. The sulfide particles of the second electrode 220s may include, as an example, sulfide particles which are the same as those of the solid electrolyte. If the electrolyte 230 is a solid electrolyte in a solid state, it is often implemented as the composite electrode (e.g., the second electrode 220a). The composite electrode 220a has an advantage of improving the contact with the electrolyte 230.

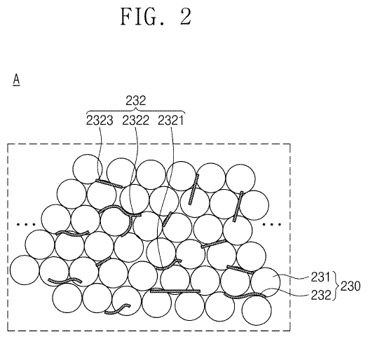

FIG. 2 is a view for describing a solid electrolyte according to an embodiment of the inventive concept, and is an enlarged view of region A of FIG. 1A and FIG. 1B.

Referring to FIG. 2, the electrolyte 230 may include sulfide particles 231 and a fiber 232.

In an embodiment, the sulfide particles 231 may include lithium phosphorus sulfur chloride (LPSCl) sulfide. In an embodiment, the sulfide particles 231 may have a spherical shape. In the electrolyte 230, the weight of the sulfide particles 231 may be 98 wt % to 99.9 wt % of the weight of the electrolyte 230.

The fiber 232 may be a fibril 232. The fiber 232 may include polytetrafluoroethylene (PTFE). In the electrolyte 230, the weight of polytetrafluoroethylene may be 0.1 wt % to 2 wt % of the weight of the electrolyte 230. Polytetrafluoroethylene may have a number average molecular weight (Mn) of 500 kg/mol to 20,000 kg/mol, 10,000 kg/mol to 15,000 kg/mol, or 12,895 kg/mol. The fiber 232 may be produced from polytetrafluoroethylene particles having an average particle size of 100 μm to 1,000 μm, or 500 μm. The fiber 232 may include a first fiber 2321, a second fiber 2322, and a third fiber 2323. The first fiber 2321 may have a curved shape. The second fiber 2322 may have a curved shape having a portion branch out into two. The third fiber 2323 may have a linear shape. The shape of the fiber 232 is not limited thereto.

The fiber 232 may be positioned between a plurality of sulfide particles 231. The fiber 232 may be in contact with the sulfide particles 231. The fiber 232 may surround at least some of the sulfide particles 231 or may contact at least some of the sulfide particles 231. The fiber 232 may have a thickness of 0.001 μm to 50 μm or less, 0.005 μm to 10 μm or less, 0.01 μm to 5 μm or less, 0.05 μm to 1 μm or less, or 0.1 μm to 0.5 μm or less. The fiber 232 may have a thin thread shape.

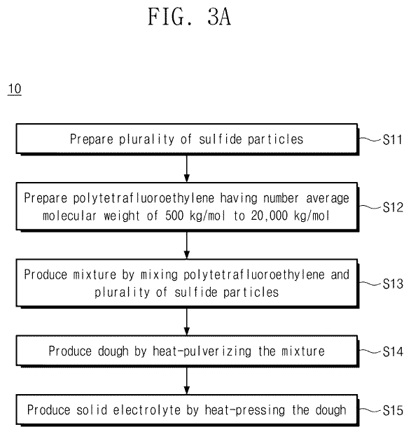

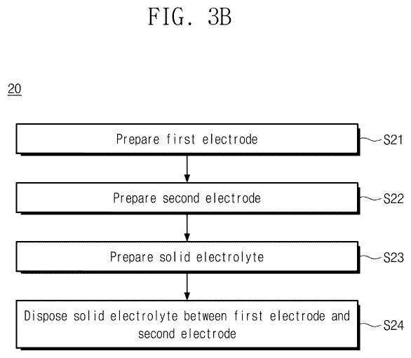

FIG. 3A is a flowchart of a method for producing a solid electrolyte according to an embodiment of the inventive concept.

Referring to FIG. 3A, there is provided a method for producing a solid electrolyte according to an embodiment of the inventive concept. In this case, the solid electrolyte may be produced by a dry production method in which a liquid solvent is not used. The production method 10 of a solid electrolyte may include preparing a plurality of sulfide particles S11, preparing polytetrafluoroethylene having a number average molecular weight of 500 kg/mol to 20,000 kg/mol S12, producing a mixture by mixing the polytetrafluoroethylene and the plurality of sulfide particles S13, producing a dough by heat-pulverizing the mixture S14, and producing a solid electrolyte by heat-pressing the dough S15.

The preparing of a plurality of sulfide particles S11 may include preparing a plurality of LPSCl particles. The preparing of a plurality of LPSCl particles may include preparing of a plurality of Li₆PS₅Cl particles.

The preparing of polytetrafluoroethylene having a number average molecular weight of 500 kg/mol to 20,000 kg/mol S12 may include preparing polytetrafluoroethylene powder having a number average molecular weight of 500 kg/mol to 20,000 kg/mol. The preparing of polytetrafluoroethylene powder having a number average molecular weight of 500 kg/mol to 20,000 kg/mol may include preparing polytetrafluoroethylene powder having a number average molecular weight of 500 kg/mol to 20,000 kg/mol and having an average particle size of 100 μm to 1,000 μm.

The producing of a mixture by mixing the polytetrafluoroethylene and the plurality of sulfide particles S13 may include producing of a mixture by mixing the polytetrafluoroethylene and the plurality of sulfide particles at a weight ratio 98:2 to 99.9:0.1. Various methods in which high energy is applied may be utilized as a method for the mixing, such as mixing using a magnetic bar, as well as a planetary mixer, a planetary ball milling, an ultrasonic process, a homogenizer, and a centrifugal mixer. As an example, the producing of a mixture S13 may include producing a mixture through a mixer.

The producing of a dough by heat-pulverizing the mixture S14 may include producing a dough by heat-pulverizing the mixture at 60° C. to 140° C., 70° C. to 130° C., 80° C. to 120° C., 90° C. to 110° C., or 100° C. The producing of a dough by heat-pulverizing the mixture S14 may include performing a pulverizing process by using a mortar and a pestle. As an example, the producing of a dough by heat-pulverizing the mixture S14 may include performing a pulverizing process in a dry manner (i.e., not introducing a liquid solvent). As an example, the producing of a dough by heat-pulverizing the mixture S14 may include producing a dough by heat-pulverizing the mixture for 100 seconds to 400 seconds, and as an example, may include producing a dough by heat-pulverizing the mixture for 240 seconds.

The producing of a solid electrolyte by heat-pressing the dough S15 may include pushing the dough into an empty space between a plurality of press rolls rotating at a temperature of 60° C. to 140° C., 70° C. to 130° C., 80° C. to 120° C., 90° C. to 110° C., or 100° C. The producing of a solid electrolyte by heat-pressing the dough S15 may include pushing the dough into the empty space two or more times while reducing the empty space between the press rolls. The producing of a solid electrolyte by heat-pressing the dough S15 may include pushing the dough into an empty space set to 100 μm between the press rolls, pushing the dough into an empty space set to 75 μm between the press rolls, pushing the dough into an empty space set to 50 μm between the press rolls, and pushing the dough into an empty space set to 30 μm between the press rolls.

FIG. 3B is a flowchart of a method for manufacturing a secondary battery according to an embodiment of the inventive concept.

Referring to FIG. 3B, there is provided a method for manufacturing a secondary battery 20 according to an embodiment of the inventive concept. The manufacturing method of a secondary battery 20 may include preparing a first electrode S21, preparing a second electrode S22, preparing a solid electrolyte S23, and disposing the solid electrolyte between the first electrode and the second electrode S24. The preparing of a solid electrolyte S23 is the same as the process as shown in FIG. 3A.

The preparing of a first electrode S21 may include, as an example, preparing an anode including an alloy of lithium (Li) and indium (In). The preparing of a second electrode S22 may include, as an example, preparing a cathode including a lithium cobalt oxide (LCO) cathode material.

Hereinafter, Examples and Test Examples are presented. Examples and Test Examples are largely divided into [Polytetrafluoroethylene (PTFE) particle test], [Mixture of polytetrafluoroethylene (PTFE) and sulfide test], and [Solid electrolyte test].

### Polytetrafluoroethylene (PTFE) Particle Test

### <Test>Selecting of PTFE

### Example 1

### Selection of PTFE Molecular Weight

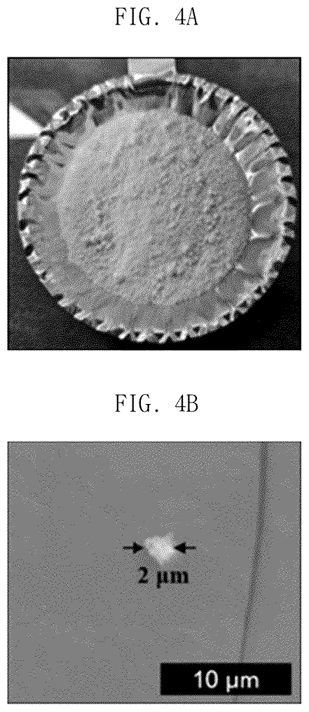

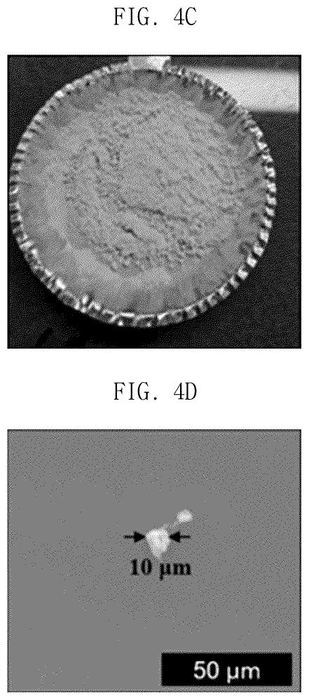

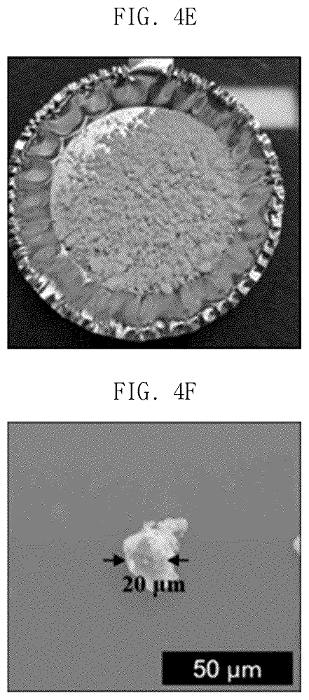

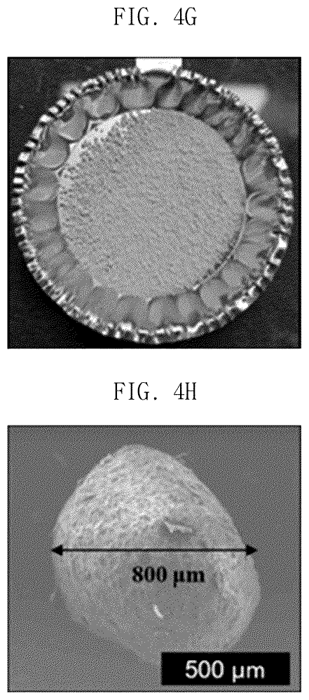

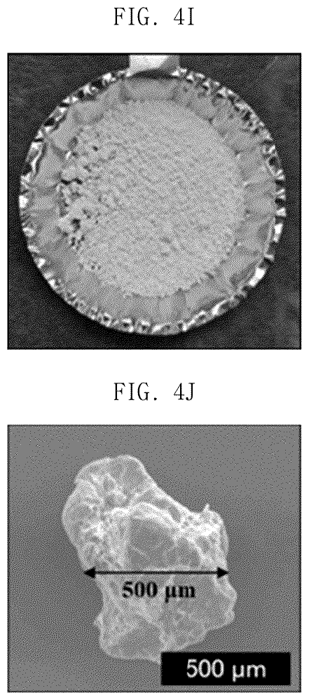

Polytetrafluoroethylene (PTFE) particles of Example 1-1 to Example 1-5 presented in Table 1 below were selected. FIG. 4A shows the polytetrafluoroethylene (PTFE) particles of Example 1-1, and FIG. 4B shows the result of SEM observation of Example 1-1. FIG. 4C shows the polytetrafluoroethylene (PTFE) particles of Example 1-2, and FIG. 4D shows the result of SEM observation of Example 1-2. FIG. 4E shows the polytetrafluoroethylene (PTFE) particles of Example 1-3, and FIG. 4F shows the result of SEM observation of Example 1-3. FIG. 4G shows the polytetrafluoroethylene (PTFE) particles of Example 1-4, and FIG. 4H shows the result of SEM observation of Example 1-4. FIG. 4I shows the polytetrafluoroethylene (PTFE) particles of Example 1-5, and FIG. 4J shows the result of SEM observation of Example 1-5.

TABLE 1

| | Average particle | Number average |
|---|---|---|
| | diameter (μm) | molecular weight (kg/mol) |
| Example 1-1 | 2 | 19 |
| Example 1-2 | 10 | 25 |
| Example 1-3 | 20 | 2294 |
| Example 1-4 | 800 | 2372 |
| Example 1-5 | 500 | 12895 |

### Example 2

### Production of Tensile Test Under Room Temperature Condition

The particles of each of Example 1-1 to Example 1-5 were used and pressed under a room temperature condition, thereby producing Example 2-1 to Example 2-5, which are cylindrical samples.

### Results of Tensile Test and SEM Observation Test for Example 2

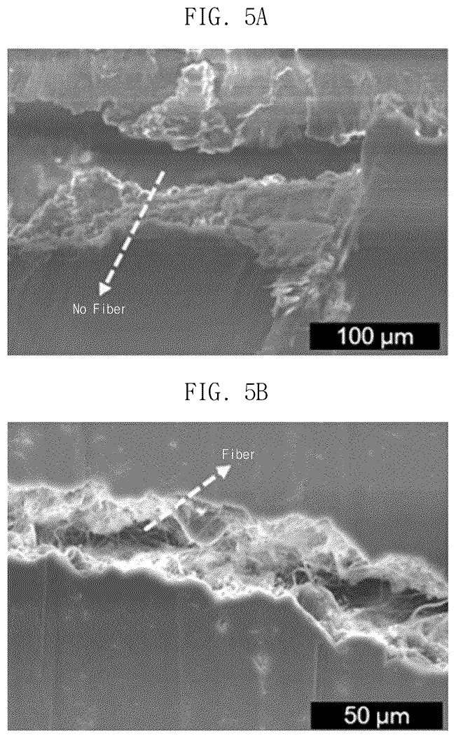

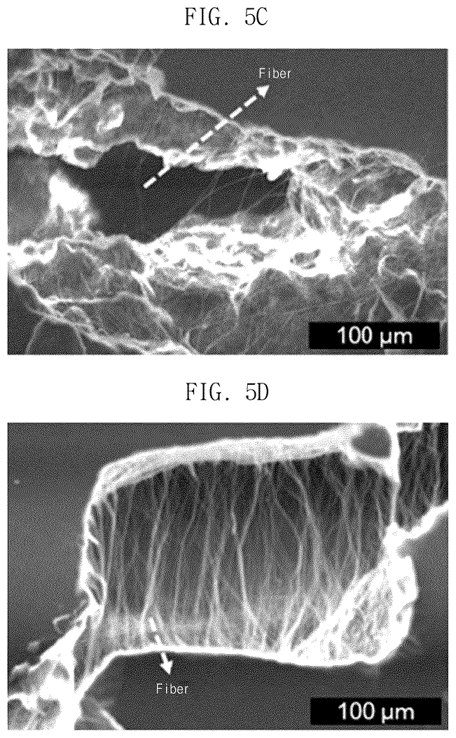

A tensile test, i.e., a stress-strain test was performed on Example 2. After the tensile test, an SEM observation test was performed.

[Table 2] shows results of the SEM observation test for Example 2-1 to Example 2-5 after the tensile test. FIG. 5A shows the result of SEM observation of Example 2-2 after the tensile test. FIG. 5B shows the result of SEM observation of Example 2-3 after the tensile test. FIG. 5C shows the result of SEM observation of Example 2-4 after the tensile test. FIG. 5D shows the result of SEM observation of Example 2-5 after the tensile test.

TABLE 2

| | Results of fiber observation |
|---|---|
| Example 2-1 | Not observed |
| Example 2-2 | Not observed |
| Example 2-3 | Observed |
| Example 2-4 | Observed |
| Example 2-5 | Observed (the largest number of fibers) |

Referring to Table 2, and FIG. 5A to FIG. 5D, in the case of Example 2-1 and Example 2-2, which have a number average molecular weight of 19 kg/mol and 25 kg/mol, respectively, no thread-like thin fiber was observed around a crack even though a tensile stress was applied at room temperature. On the other hand, it has been confirmed that in the case of Example 2-3, Example 2-4, and Example 2-5, which have a number average molecular weight (kg/mol) of 2,294, 2,372, and 12,895, respectively, fibers were observed.

The generation of the fibers observed in Example 2-3, Example 2-4, and Example 2-5 means that polytetrafluoroethylene (PTFE) serves well as a binder for binding particles in the solid electrolyte. Particularly, it has been confirmed that polytetrafluoroethylene (PTFE) particles having the a number average molecular weight (kg/mol) of Example 2-5 may best serve as a binder.

As a result of the tensile test, a tensile stress (σ) graph according to a tensile strain (ε) of each Example was obtained. Thereafter, the maximum tensile stress and a toughness value were calculated.

[Table 3] shows results of the tensile test for Example 2.

TABLE 3

| | Maximum tensile stress | |
|---|---|---|
| | (MPa) | Toughness (J/m³) |
| Example 2-2 | 0.3 | 7.6 × 10² |
| Example 2-3 | 0.7 | 2.1 × 10⁴ |
| Example 2-4 | 0.7 | 2.1 × 10⁴ |
| Example 2-5 | 0.7 | 3.0 × 10⁴ |

As a result of the test for Example 2, it has been confirmed that in the case of Example 2-3 to Example 2-5, the maximum tensile stress (MPa) and toughness (J/m³) were excellent, so that the effect as a binder was also excellent.

In order to confirm an optimal process condition for PTFE fibrillation, the following test was performed.

### <Test>Test for Confirming Optimal Fibrillation Process Condition of PTFE

### <Test for Confirming Optimal Mechanical Pulverization Time>

### Measurement of Degree of Fibrillation According to Mechanical Pulverization Time Under Condition of 100° C.

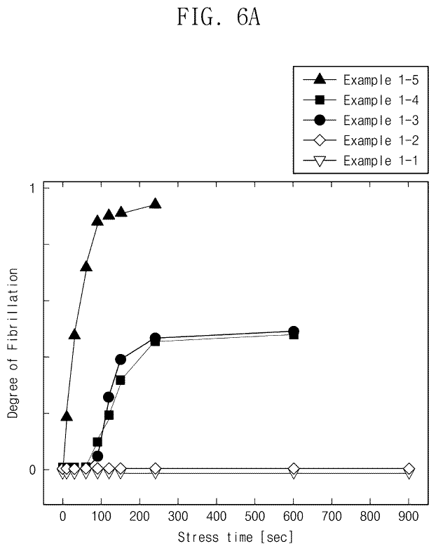

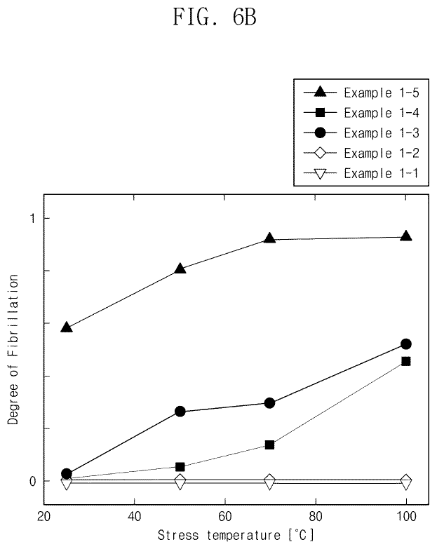

The particles of each of Example 1-1 to Example 1-5 were used to perform a test on the degree of fibrillation according to the stress time (sec) under a condition of 100° C. Results of the corresponding test are shown in FIG. 6A.

Referring to the test graph for the samples of Example 1-3 to Example 1-5 in FIG. 6A, as a result of the test, it has been confirmed that the degree of fibrillation gradually increases when the pulverization is performed for up to 240 seconds but it has been confirmed that the degree of fibrillation reaches a saturation state when the pulverization is performed for more than 240 seconds. Based on the above results, it has been confirmed that performing pulverization for 240 seconds is an optimal condition for satisfying both the process cost and the degree of fibrillation under the condition of 100° C.

### <Test for Confirming Optimal Pulverization Temperature>

### Measurement of Degree of Fibrillation According to Changing Temperature Under Condition of Performing Pulverization for 240 Seconds

The particles of each of Example 1-1 to Example 1-5 were used to perform a test on the degree of fibrillation according to the stress temperature (° C.) under a condition of performing pulverization for 240 seconds. Results of the corresponding test are shown in FIG. 6B.

Referring to the test graph for the samples of Example 1-3 to Example 1-5 in FIG. 6B, as a result of the test, it has been confirmed that the degree of fibrillation increases as the stress temperature increases below 100° C. Particularly, in the case of the sample of Example 1-5 having a molecular weight of 12,895 kg/mol, it has been confirmed that the degree of fibrosis is saturated at a temperature of 70° C. or higher, and in the case of the samples of Example 1-3 and Example 1-4 having a molecular weight of 2,294 kg/mol and 2,372 kg/mol, respectively, it has been confirmed that the temperature condition of 100° C. exhibits a degree of fibrillation sufficient to produce a binder.

A fiber production test was performed by setting fiber production conditions to a stress temperature of 100° C. and a pulverization time of 240 seconds.

### Example 3

### Production of Fiber Under Conditions of 100° C. and Pulverization Time of 240 Seconds

The particles of each of Example 1-1 to Example 1-5 were used and pulverized at 100° C. for 240 seconds, thereby producing fibers of Example 3-1 to Example 3-5.

### Results of SEM Observation Test for <Example 3>

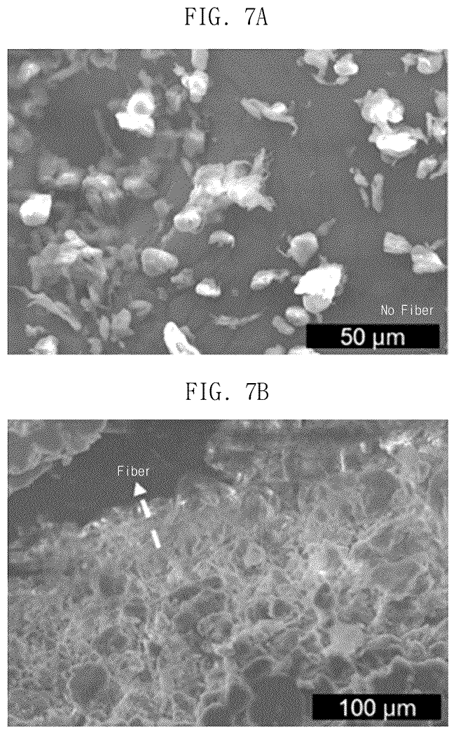

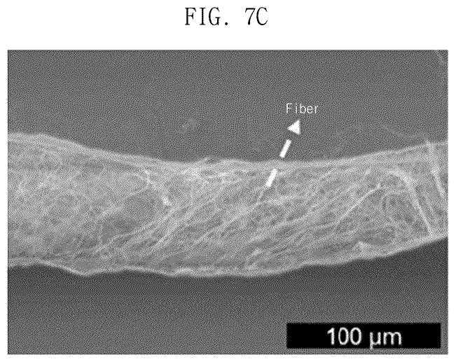

Whether the fiber was produced well was confirmed through SEM observation for Example 3. [Table 4] shows results of SEM observation test for Example 3. FIG. 7A shows the result of SEM observation of Example 3-2. FIG. 7B shows the result of SEM observation of Example 3-4. FIG. 7C shows the result of SEM observation of Example 3-5.

TABLE 4

| | Results of fiber observation |
|---|---|
| Example 3-1 | Not observed |
| Example 3-2 | Not observed |
| Example 3-3 | Observed |
| Example 3-4 | Observed |
| Example 3-5 | Observed (the largest number of fibers) |

Referring to Table 4, and FIG. 7A to FIG. 7C, as in the case of the results of the SEM observation test for Example 2 described above, it has been confirmed that no fiber was produced in the case of Example 3-1 and Example 3-2, but a fiber form was produced in the case of Example 3-3 to Example 3-5.

### Results of Tensile Test for Example 3

A tensile test was performed on Example 3 in the same manner as the tensile test for Example 2 described above. [Table 5] shows results of the tensile test for Example 3.

TABLE 5

| | Maximum tensile | |
|---|---|---|
| | stress (MPa) | Toughness (J/m³) |
| Example 3-4 | 1.8 | 8.1 × 10⁴ |
| Example 3-5 | 1.9 | 2.1 × 10⁵ |

Referring to [Table 3] and [Table 5] together, it can be confirmed that it is possible to produce a PTFE tensile test sample having an increased maximum tensile stress (MPa) and an increased toughness (J/m³) when pulverization is performed for 240 seconds under a condition of 100° C.

The above-described test result is a result of a fiber production test using only PTFE particles. When PTFE particles and LPSCl-based sulfide particles are mixed, in order to test physical properties of a mixture thereof, a dough produced in a process of producing a solid electrolyte as follows was used for the test.

### [Test on Mixture of Polytetrafluoroethylene (PTFE) and Sulfide]

### Example 4

### Production of Dough Under Conditions of 100° C. and Pulverization Time of 240 Seconds

The particles of each of Examples 1-2, 1-4, and 1-5 were mixed with Li₆PS₅Cl sulfide particles at a weight ratio of 2:98. Thereafter, the mixture was pulverized at 100° C. for 240 seconds, and whether a dough was produced or not was observed with the naked eye for Examples 4-2, 4-4, and 4-5.

In the present specification, a dough may refer to a state in which adhesion is generated between components constituting the dough. In a powder state, there is no adhesion, but PTFE may perform an adhesive function due to fibrillation. As a result, a dough may be formed by adhesion with the sulfide particles.

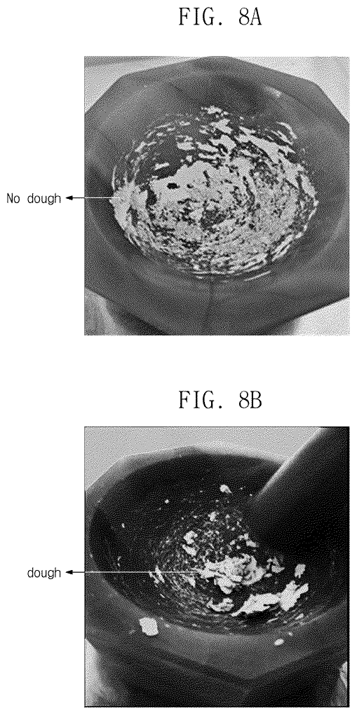

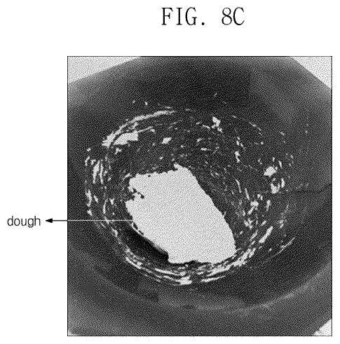

FIG. 8A shows the result of visual observation of Example 4-2 produced based on the particles of Example 1-2. FIG. 8B shows the result of visual observation of Example 4-4 produced based on the particles of Example 1-4. FIG. 8C shows the result of visual observation of Example 4-5 produced based on the particles of Example 1-5.

As a result of the test, in the case of FIG. 8A produced based on the particles of Example 1-2, it can be seen that the powder state remained without producing a dough. In the case of FIG. 8B and FIG. 8C respectively produced based on the particles of Example 1-4 and Example 1-5, it can be confirmed that a dough was produced.

In the case of FIG. 8B and FIG. 8C, PTFE respectively having a number average molecular weight of 2,372 kg/mol and a number average molecular weight of 12,895 kg/mol effectively served as a binder for binding Li₆PS₅Cl particles, and as a result, a dough was formed due to adhesion with the Li₆PS₅Cl particles. Particularly, in the case of FIG. 8C, it can be confirmed that a dough having a larger area than that of FIG. 8B is formed, and since fibrillation occurs most actively, the role of a binder is most effectively performed.

### Results of Tensile Test for Example 4

A tensile test was performed for the doughs of Example 4-4 and Example 4-5 in which a dough was produced. A tensile test was performed in the same manner as the tensile test for Example 2 described above. In addition, the state after the maximum tensile stress was applied was observed with the naked eye. In addition, the state when the maximum tensile stress was applied was observed by SEM.

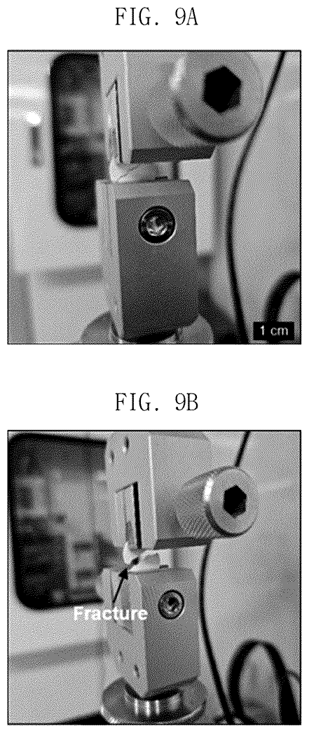

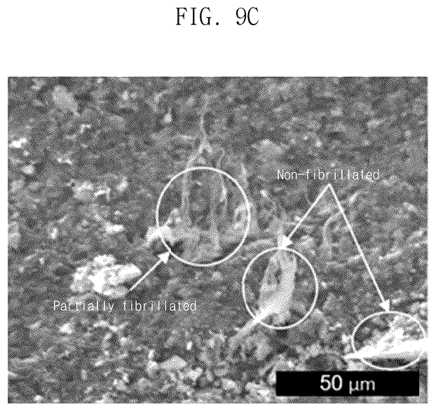

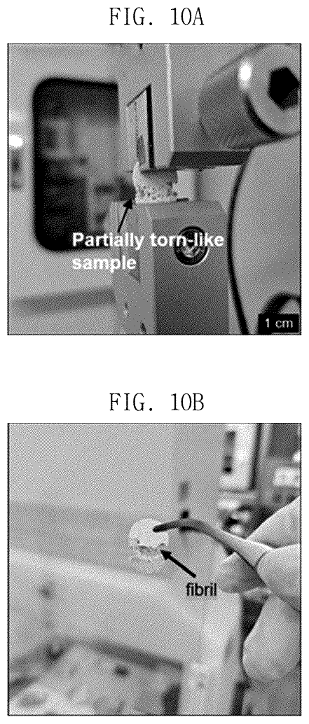

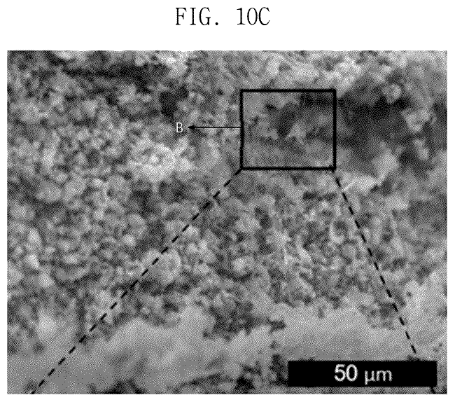

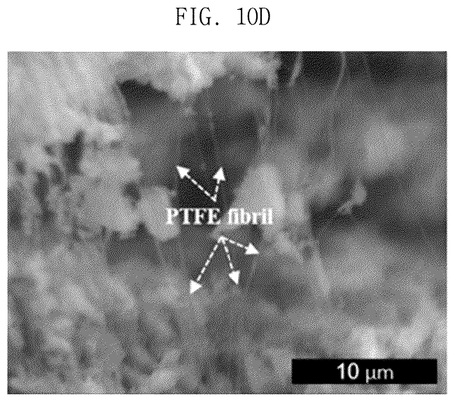

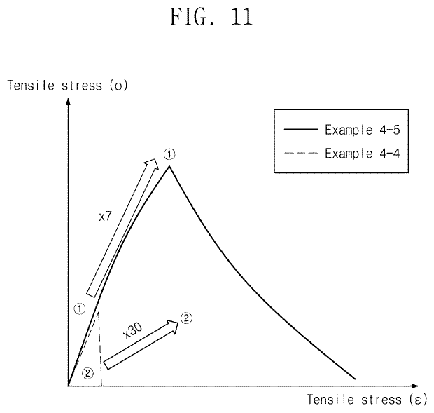

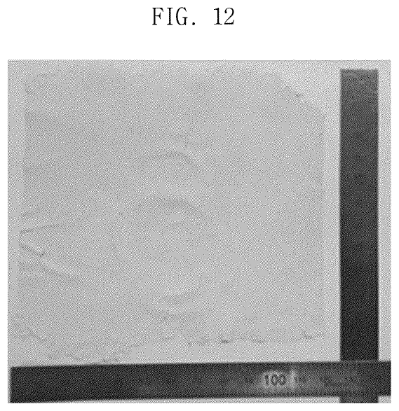

FIG. 9A and FIG. 9B show the state of Example 4-4 dough after the maximum tensile stress is applied. FIG. 9C shows the state of Example 4-4 dough observed by SEM when the maximum tensile stress is applied. FIG. 10A and FIG. 10B show the state of Example 4-5 dough after the maximum tensile stress is applied. FIG. 10C shows the state of Example 4-5 dough observed by SEM when the maximum tensile stress is applied. FIG. 10D is an enlarged view of region B of FIG. 10C. FIG. 11 shows the result of comparing stress-strain curves of Example 4-4 dough and Example 4-5 dough.

Referring to FIG. 9A, FIG. 9B, FIG. 10A, and FIG. 10B together, Example 4-4 dough was fractured when the maximum tensile stress was applied, but Example 4-5 dough was partially torn first when the maximum tensile stress was applied, and not fractured.

From this, it can be confirmed that in both Example 4-4 dough and Example 4-5 dough, a PTFE binder serves to fix LPSCl sulfide particles, but in Example 4-5 dough, the PTFE binder serves better to fix the LPSCl sulfide particles than that in Example 4-4 dough.

Referring to FIG. 9C, FIG. 10C, and FIG. 10D together, in the case of Example 4-4 dough, although the PTFE was fibrillated, it can be confirmed that some PTFE fibers were aggregated together without surrounding the LPSCl sulfide particles. On the other hand, in the case of Example 4-5 dough, it can be confirmed that PTFE fibers surrounded the LPSCl sulfide particles relatively evenly without being aggregated together.

Referring to FIG. 11, it was confirmed that Example 4-5 showed results that the maximum tensile stress was 7 times greater and the toughness was 30 times greater than those of Example 4-4.

### [Test on Solid Electrolyte]

### Example 5

Based on the particles of Examples 1-5 which had the best physical properties according to the result of the dough production test, a solid electrolyte test was performed. First, a mixture was produced by mixing the particles of Example 1-5 and the Li₆PS₅Cl particles at a weight ratio of 0.5:99.5. Thereafter, the mixture was pulverized in a mixer at 100° C. for 240 seconds to produce a dough. A solid electrolyte of Example 5 was produced by performing unidirectional heat-pressing on the produced dough.

As the unidirectional heat-pressing, a process of pushing a dough into an empty space between two press rolls rotating at 100° C. was performed. In this case, in order to reduce the thickness of the dough, the size of the empty space was reduced in the order of 100 μm, 75 μm, 50 μm, and 30 μm, and the process of pushing the dough was performed four times in total.

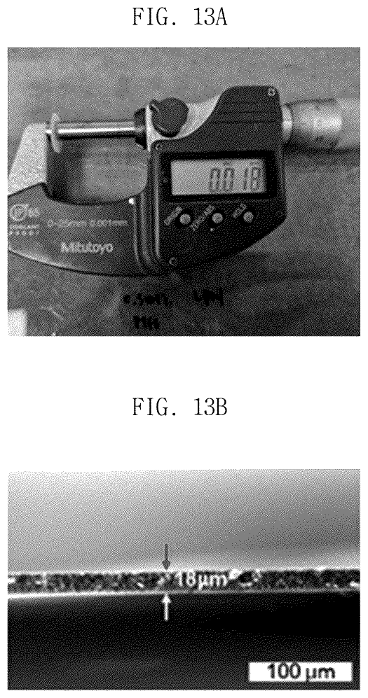

FIG. 12 illustrates Example 5 produced. Referring to FIG. 12, the solid electrolyte having a width of 12 cm and a length of 12 cm was produced through a solid electrolyte production test. The solid electrolyte of FIG. 12 may be cut and used if necessary.

### <Results of Thickness Measurement Using Micrometer>

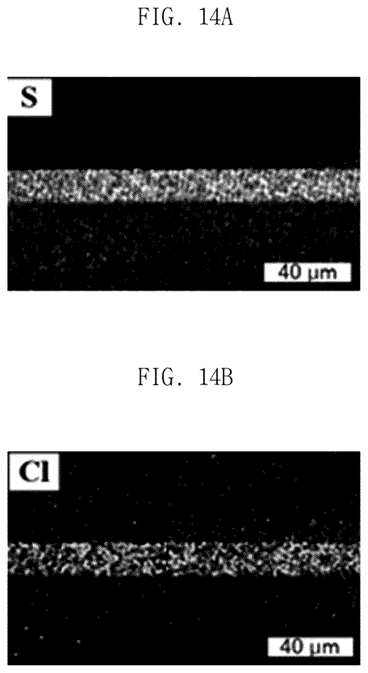

The thickness of the produced Example 5 was measured by using a micrometer. FIG. 13A illustrates the result of measuring the thickness of Example 5 by using a micrometer, and it was confirmed that the thickness was 18 μm.

### <Results of Thickness Measurement Using High-Magnification SEM>

The thickness of Example 5 produced was measured by using a high-magnification SEM. FIG. 13B illustrates the result of measuring the thickness of Example 5 by using a high-magnification SEM, and it was confirmed that the thickness measurement result using the micrometer and the test result were the same in that the thickness was 18 μm.

### <EDS Element Mapping Results>

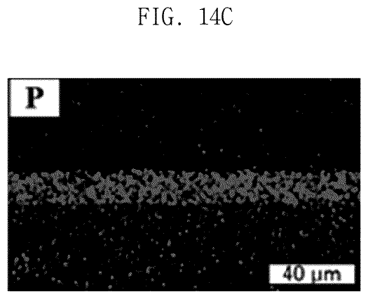

An EDS element mapping test was performed by using Example 5 as a sample. This is to confirm whether the Li₆PS₅Cl particles were dispersed well in the solid electrolyte. EDS mapping was performed by determining P, S, and Cl elements, which are elements of Li₆PS₅Cl. FIG. 14A is the result of EDS mapping of an S element of Example 5. FIG. 14B is the result of EDS mapping of a Cl element of Example 5. FIG. 14C is the result of EDS mapping of a P element of Example 5.

Referring to FIG. 14A to FIG. 14C, it was confirmed that the S element, the Cl element, and the P element were dispersed well in the solid electrolyte, and it was confirmed that not only the solid electrolyte was successfully produced, but also the polytetrafluoroethylene (PTFE) particles of Example 1-5 successfully bound the Li₆PS₅Cl particles.

### <Results of Ion Conductivity Measurement>

Electrical conductance (mS) and ion conductivity (mS/cm)) measurement tests were performed by using Example 5 as a sample. [Table 6] shows results of measuring the electrical conductance (mS) and the ion conductivity (mS/cm) of Example 5.

TABLE 6

| | Electrical conductance | Ion conductivity |
|---|---|---|
| Sample | (mS) | (mS/cm) |
| Example 5 | 625 | 0.84 |

As a result of the tests, it was confirmed that the solid electrolyte of Example 5 had electrical conductance and ion conductivity values applicable for a secondary battery.

### <Results of Evaluation of Charge/Discharge Cycling of Lithium Secondary Battery>

A lithium secondary battery of Example 6 was manufactured by using Example 5 as a sample. As a cathode, a cathode including a lithium cobalt oxide (LCO) cathode material was used, and as an anode, an anode including an alloy of lithium (Li) and indium (In) was used. A lithium secondary battery of Example 6 was manufactured by disposing the solid electrolyte of Example 5 between the cathode and the anode.

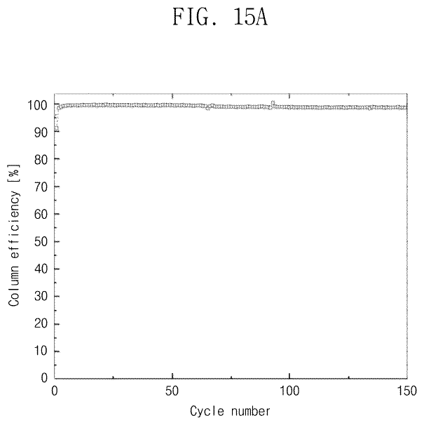

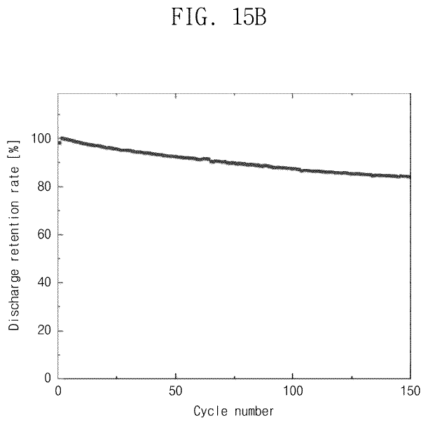

Thereafter, a charge/discharge cycling evaluation was performed by using Example 6 as a sample under a 0.3 C charge/discharge condition. The Coulombic efficiency (%) and the discharge capacity retention rate (%) were measured. FIG. 15A shows the Coulombic efficiency according to the charge/discharge cycle number of Example 6. FIG. 15B shows the discharge capacity retention rate according to the charge/discharge cycle number of Example 6.

Referring to FIG. 15A, it can be seen that Example 6 shows high Coulombic efficiency. Referring to FIG. 15B, in spite of 150 cycles, a high discharge capacity retention rate of 84% was exhibited, and it was confirmed that a discharge capacity retention rate applicable for a secondary battery was exhibited.

A solid electrolyte and a secondary battery according to the inventive concept may have improved thermal stability, and improved electrochemical properties.

Embodiments of the present invention have been described with reference to the accompanying drawings. However, the present invention may be implemented in other detailed forms without changing the technical spirit or necessary features thereof. It is therefore to be understood that the above-described embodiments are illustrative in all aspects and not restrictive.

What is claimed is:

1. A lithium secondary battery comprising:
a first electrode;
a second electrode spaced apart from the first electrode; and
a solid electrolyte disposed between the first electrode and the second electrode, wherein the solid electrolyte includes:
a fiber including polytetrafluoroethylene having a number average molecular weight of 500 kg/mol to 20,000 kg/mol; and
a plurality of sulfide particles,
wherein the fiber is in contact with at least some of the sulfide particles.

2. The lithium secondary battery of claim 1, wherein the fiber has a thickness of 5 μm or less.

3. The lithium secondary battery of claim 1, wherein the solid electrolyte has a thickness of 10 μm to 99 μm.

4. The lithium secondary battery of claim 1, wherein the sulfide comprises LPSCl sulfide.

5. The lithium secondary battery of claim 1, wherein the weight of the polytetrafluoroethylene is 0.1 wt % to 2 wt % of the weight of the solid electrolyte.

6. The lithium secondary battery of claim 1, wherein the fiber has a shape of any one or more of a linear shape, a curved shape, and a curved shape having a branching portion.

7. The lithium secondary battery of claim 1, wherein at least one of the first electrode and the second electrode comprises the same particles as sulfide particles included in the solid electrolyte.

8. The lithium secondary battery of claim 1, wherein the number average molecular weight of the polytetrafluoroethylene is 10,000 kg/mol to 15,000 kg/mol.

9. The lithium secondary battery of claim 1, wherein the weight of the sulfide particles is 98 wt % to 99.9 wt % of the weight of the solid electrolyte.

10. The lithium secondary battery of claim 1, wherein the number average molecular weight of the polytetrafluoroethylene is 12,895 kg/mol.

11. A method for manufacturing a lithium secondary battery, the method comprising:
preparing a first electrode;
preparing a second electrode;
preparing a solid electrolyte; and
disposing the solid electrolyte between the first electrode and the second electrode,
wherein the preparing of the solid electrolyte includes:
preparing a plurality of sulfide particles;
preparing polytetrafluoroethylene having a number average molecular weight of 500 kg/mol to 20,000 kg/mol;
producing a mixture by mixing the polytetrafluoroethylene and the plurality of sulfide particles;
producing a dough by heat-pulverizing the mixture; and
producing a solid electrolyte by heat-pressing the dough.

12. The method of claim 11, wherein in the producing of the mixture, the weight ratio between the polytetrafluoroethylene and the sulfide particles is 0.1:99.9 to 2:98.

13. The method of claim 11, wherein in the preparing of the polytetrafluoroethylene, the number average molecular weight of the polytetrafluoroethylene is 10,000 kg/mol to 15,000 kg/mol.

14. The method of claim 11, wherein in the preparing of the plurality of sulfide particles, the plurality of sulfide particles comprise LPSCl sulfide.

15. The method of claim 11, wherein the producing of the dough is performed at 60° C. to 140° C.

16. The method of claim 11, wherein in the producing of the dough, the heat-pulverization is performed for 100 seconds to 400 seconds.

17. The method of claim 11, wherein in the producing of the solid electrolyte, the heat-pressing is unidirectional heat-pressing.

18. The method of claim 11, wherein in the producing of the solid electrolyte, the heat-pressing is performed at 60° C. to 140° C.

19. The method of claim 11, wherein in the producing of the solid electrolyte, the heat-pressing is performed by using a plurality of press rolls.

20. A method for producing a solid electrolyte for a lithium secondary battery, the method comprising:
preparing a plurality of sulfide particles;
preparing polytetrafluoroethylene having a number average molecular weight of 500 kg/mol to 20,000 kg/mol;
producing a mixture by mixing the polytetrafluoroethylene and the plurality of sulfide particles;
producing a dough by heat-pulverizing the mixture; and
producing a solid electrolyte by heat-pressing the dough.
